(19) United States
(12) Patent Application Publication
(10) Pub. No.: US 2026/0233243 A1
(43) Pub. Date: Aug. 13, 2026

(54) INDICATOR IN MOLDED DISPENSER AND METHODS OF MAKING THE SAME

(71) Applicant: Silgan Dispensing Systems Corporation, Richmond, VA (US)

(72) Inventor: Brandon Ramsuer, Henrico, VA (US)

(73) Assignee: Silgan Dispensing Systems Corporation, Grandview, MO (US)

(21) Appl. No.: 19/150,655

(22) PCT Filed: Jan. 30, 2024
(86) PCT No.: PCT/US2024/013498

§ 371 Date: Jul. 24, 2025

Related U.S. Application Data
(60) Provisional application No. 63/442,603, filed on Feb. 1, 2023.

(51) Int. Cl. B05B 11/10; A47K 5/12; B29C 45/26

(52) U.S. Cl. CPC B05B 11/1042; A47K 5/1205; B29C 45/26

(57) ABSTRACT

An indicator in a component of a dispensing device is produced by molding a recess into a top surface of the component, a bottom surface of the component, or both, such that the indicator wall has a thickness that is less than that of the component wall adjacent the indicator to allow a greater passage of light through the indicator.

### BACKGROUND OF THE INVENTION

### Field of the Invention

Embodiments of the invention relate to molded dispenser parts having indicators molded therein to provide visual prompts to a user and methods for making such molded dispenser parts and indicators in said parts.

### Description of Related Art

Dispenser products such as pumps and closures often utilize visual indicators to assist with the operation of the pump or to provide a user with instructions on how a pump may be used or parts may be rotated, removed, or otherwise manipulated to facilitate use of the pump. For example, an arrow may be printed on the head of a pump indicating the rotational direction required to turn the pump head to unlock it and allow use of a pump to which it is attached. In other examples, nozzles on trigger sprayers include indicators on the sides of the nozzle to communicate to the user the type of spray that will be sprayed from the trigger sprayer, or an “on” or “off” state, with the nozzle in a given position.

In some instances, such visual indicators may be printed on the dispenser products after molding is completed. The application of such indicators requires at least one additional step in the assembly and/or manufacturing process-application of the indicator or design. The additional steps required to print, paint, or otherwise affix such indicators on a molded part add time to the manufacturing process and additional costs for materials and machines capable of adding the indicators to a molded part.

In other instances, a visual indicator may be created by deliberately molding a void or opening in the part so that a user may see through the opening. While such indicators reduce the costs because the void or opening is made during the molding process, the presence of voids or openings in dispenser parts is not always desirable. For instance, such voids and openings may be used in the nozzle of a trigger sprayer but an opening indicator may not be desirable in a high-end pump used in the cosmetic markets.

In still other embodiments, raised lettering, symbols, or other indications may be molded into a part to provide a desired message to a user. Such indicators are commonly used with many different dispenser products. However, such indicators are not always visible and in some cases, require additional printing or coloring to make the raised positions visible. In other instances, such raised indicators may even be molded of a different plastic or different color in a bi-injection process. Such processes, however, increase the cost of the molding and manufacturing process. In still other cases, the raised indicators have to be over-exaggerated and enlarged so that users are able to see the indicators. This is especially true in those instances where the material being used to mold the product is clear or transparent or semi-transparent.

There exists a need for an indicator creating method that provides a relatively visible indicator in molded dispenser parts that avoids the use of openings and which does not add significant costs to the manufacturing process. The need is especially great with molded parts made of plastic or resin material in which a contrast formed by a raised indicator is difficult to see.

### BRIEF SUMMARY OF THE INVENTION

According to certain embodiments of the invention a method for producing an indicator in a component of a dispensing device is provide. According to various embodiments, an indicator may be produced by thinning out a portion of the wall of a component of a dispensing device. In some instances, the portion of the wall being thinned is thinned by recessing the wall on a bottom surface of the wall of the component. In other instances, the portion of the wall being thinned is thinned by recessing the wall on a top surface of the wall of the component. In still other embodiments, the portion of the wall being thinned is thinned by recessing both a wall on the top surface and an adjacent wall on the bottom surface of the component.

In some embodiments of the invention, a pump head is molded having a indicator formed therein. The indicator includes an indicator wall having a thickness less than the thickness of the pump head wall adjacent the indicator. In various embodiments, the smallest thickness of the indicator wall may be between 20 and 80 percent that of the pump head wall adjacent the indicator. In other embodiments, the smallest thickness of the indicator wall may be between 30 and 70 percent that of the pump head wall adjacent the indicator. In still other embodiments, the smallest thickness of the indicator wall may be between 40 and 60 percent that of the pump head wall adjacent the indicator. In some additional embodiments, the thickness of the indicator wall may vary over the shape of the indicator.

An indicator in a pump head, or other dispensing device component according to other embodiments of the invention, may be formed by creating a recess in a top surface of the pump head. In other embodiments, the indicator may be made by forming a recess in a bottom surface of the pump head. In still other embodiments, the indicator may be formed by forming a recess in both the top surface and the bottom surface of a pump head or other component of a dispensing device.

In still other embodiments of the invention, an indicator may include a thinned wall and the indicator may extend away from or protrude from a top surface of the pump head or dispensing device component.

According to embodiments of the invention, an indicator allows light to pass through a portion of the indicator or allows more light to pass than does the pump head wall—or dispensing device component wall—adjacent the indicator. The increased passage of light through the indicator makes the indicator stand out on the surface of the pump head or dispensing device component. Indicators are especially useful in those instances where the pump head or dispensing device component are made of polyethylene. In such cases, the indicator—or thinned wall portion—helps to enhance the message being communicated by the indicator because additional light is allowed to pass through the indicator portion of the pump head or dispensing device component.

### BRIEF DESCRIPTION OF THE SEVERAL VIEWS OF THE DRAWINGS

While the specification concludes with claims particularly pointing out and distinctly claiming particular embodiments of the present invention, various embodiments of the invention can be more readily understood and appreciated by one of ordinary skill in the art from the following descriptions of various embodiments of the invention when read in conjunction with the accompanying drawings in which:

FIG. 1 illustrates a dispensing device according to various embodiments of the invention;

FIG. 2 illustrates a pump head having an indicator according to various embodiments of the invention;

FIG. 3 illustrates a pump head having an indicator according to various embodiments of the invention;

FIG. 4 illustrates an exploded view of an indicator in a pump head according to various embodiments of the invention;

FIG. 5 illustrates a exemplary pump wall and indicator wall transition according to various embodiments of the invention;

FIG. 6 illustrates a pump head having an indicator according to various embodiments of the invention;

FIG. 7 illustrates a bottom view of the pump head illustrated in FIG. 6;

FIG. 8 illustrates a cross-sectional view of a pump head having an indicator according to embodiments of the invention; and

FIG. 9 illustrates a cross-sectional close-up view of the indicator wall thickness of the pump head illustrated in FIG. 8.

### DETAILED DESCRIPTION OF THE INVENTION

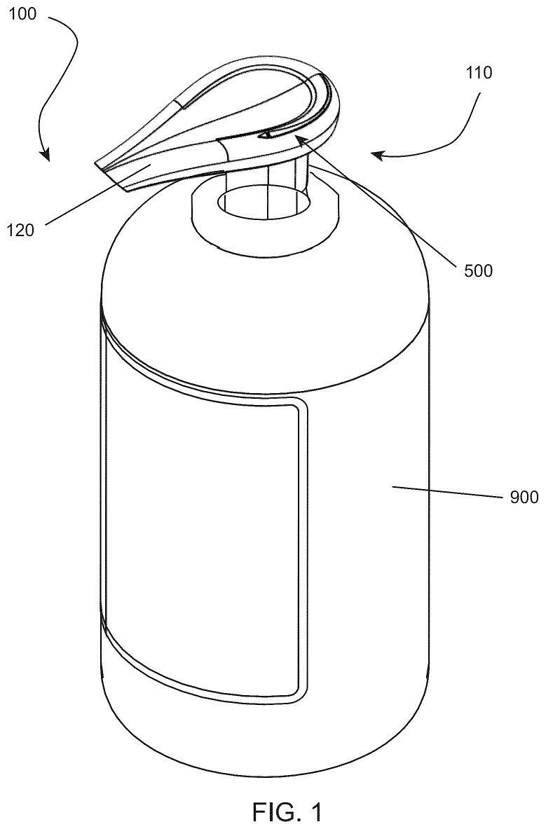

A dispensing device 100 according to certain embodiments of the invention is illustrated in FIG. 1. As illustrated, a dispensing device 100 may include a pump 110 seated on or connected to a container 900. The container 900 may include a product contained therein which may be dispensed through the pump 110 attached to the container 900. The pump 110 may include a pump head 120 upon which a user may press to actuate or move part of the pump 110 to dispense a product from the container 900. As illustrated, an indicator 500 is formed in a portion of the pump head 120 and is visible to a user. The indicator 500 shown in FIG. 1 is in the shape of an arrow.

According to various embodiments of the invention, an indicator 500 may be molded into a pump head 120. The indicator 500 may include a thinned-out portion within the pump head 120 allowing light to pass through the molded plastic. In some embodiments, the thinning may be consistent across the entire shape of the indicator 500. In other embodiments, the thinning may be gradual, with one portion having a thinned-out area varying in thickness across portions of the indicator 500. The gradual thinning through the indicator 500 creates a faded or gradient appearance to a user.

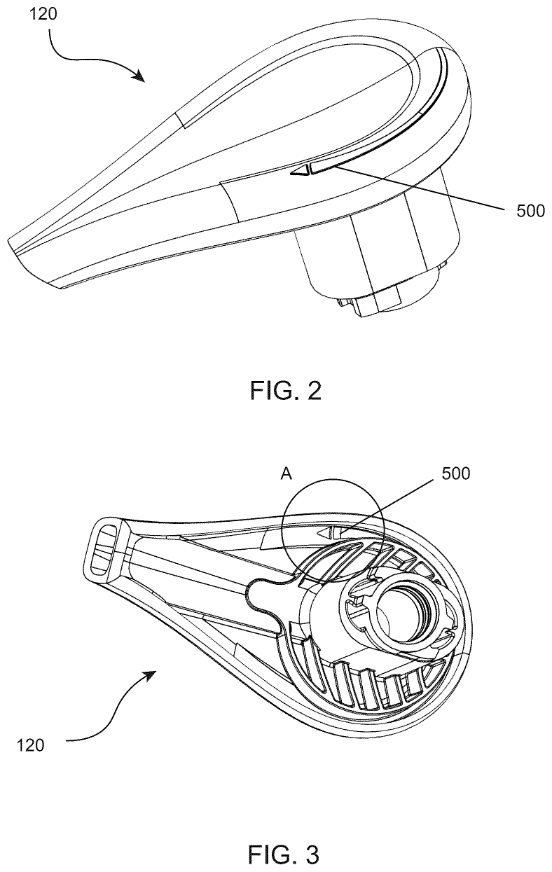

For example, a pump head 120 having an indicator 500 according to some embodiments of the invention is illustrated in FIGS. 2 through 4. The pump head 120 includes an indicator 500 that projects away from a top surface of the pump head 120. As illustrated, the indicator 500 is shaped as an arrow in this example but may be shaped differently for other parts. The indicator 500 is shown from a top view in FIG. 2. FIG. 3 illustrates a bottom view of the pump head 120 and shows that from an underside, the indicator 500 is indented in, or impressed in, the underside of the pump head 120. The depression of the indicator 500 is more easily seen in FIG. 4 which is a close-up of the view of a portion shown in circle A in FIG. 3.

As illustrated in FIG. 4, the indicator 500 includes two parts, a arrow head portion 500A and an arrow tail portion 500B. While the indicator 500 illustrated in FIGS. 2 through 4 includes two portions, indicators 500 according to embodiments of the invention may include one or more portions or multiple indicators 500 may be included and molded into a part or component of a dispensing device 100.

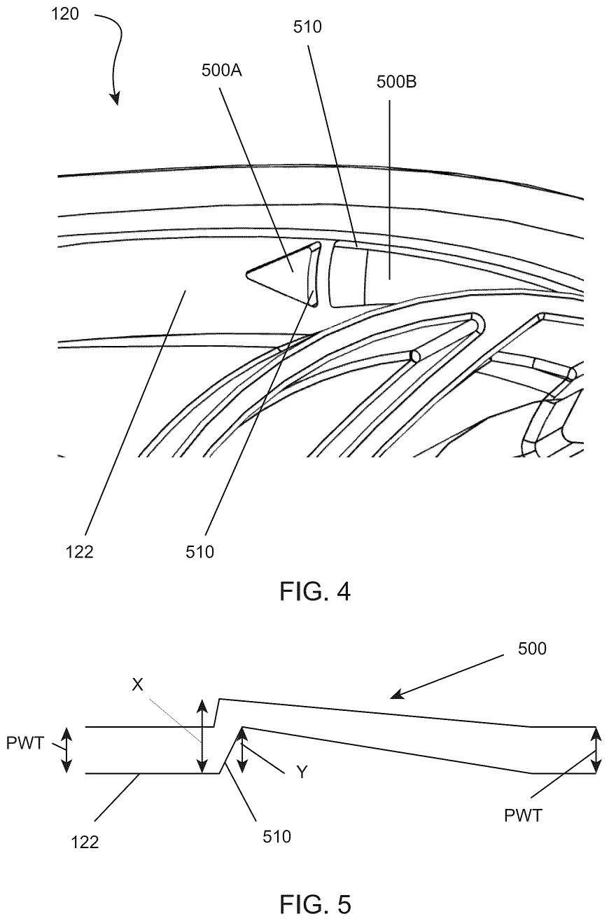

The indicator 500 illustrated in FIGS. 2 through 4 is recessed into the bottom surface 122 of the pump head 120 such that when viewed from the top of the pump head 120, as in FIG. 2, the indicator 500 appears raised and when viewed from the underside of the pump head 120, as in FIG. 4, the indicator 500 appears recessed in the bottom surface 122 thereof. The indicator 500 includes indicator side walls 510 as illustrated in FIG. 4. In some embodiments of the invention, the thickness of the wall portion of the indicator 500 is less than the thickness of the pump head wall adjacent the indicator 500. For example, FIG. 5 shows an illustration of a cross-sectional view of an indicator 500 molded according to various embodiments of the invention. The pump head wall thickness—PWT—adjacent the indicator 500 is larger than the thickness of the wall of the indicator 500. As an example, FIG. 5 shows that the thickness of the initial wall of the indicator 500 is approximately equal to the value of the distance X minus Y. In embodiments of the invention, PWT is greater than the value of X minus Y. In some embodiments, the value X minus Y is between 20 and 80 percent of PWT. In other embodiments, X minus Y may be between 30 and 70 percent of PWT. In still other embodiments, X minus Y may be between 40 and 60 percent of PWT. In some embodiments of the invention, the thickness of the indicator 500 wall may taper or change over the length of the indicator 500 such that at one end the X minus Y value is fifty percent smaller than PWT and only ten percent smaller adjacent the other end of the indicator 500.

When the thickness of the indicator 500 wall—or portions thereof—are less than the thickness of the pump head wall thickness—PWT—then light is able to pass through the indicator. This is especially true when the indicator wall thickness is about 50 percent or less the thickness of the pump head 120 wall. In those instances where the indicator 500 wall is tapered or has a varying thickness, light can pass through the indicator 500 in different amounts, creating a gradient effect or brushed effect to the indicator 500 when viewed by a user.

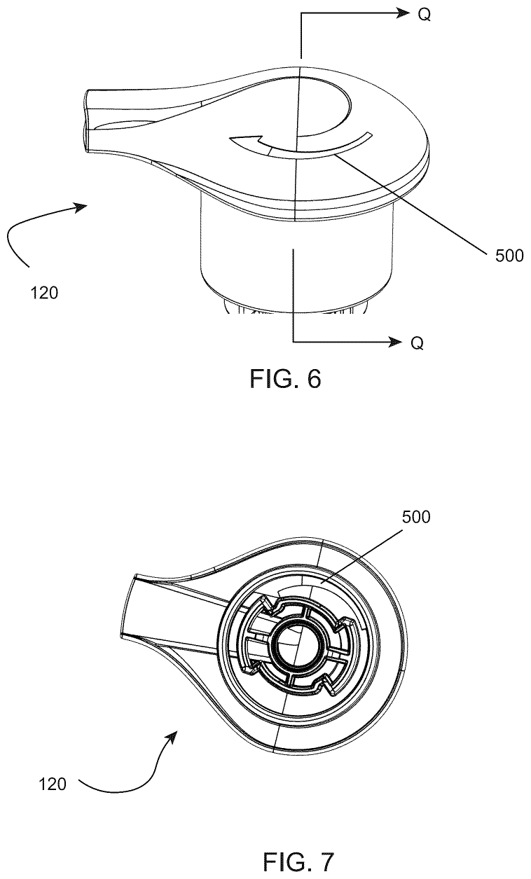

An indicator 500 in a pump head 120 according to other embodiments of the invention is illustrated in FIGS. 6 through 9. As illustrated in FIG. 6, an indicator 500 may be recessed into the top of the pump head 120 as opposed to being raised above the top wall of the pump head 120 as in FIG. 3. In some embodiments, the recess into the pump head 120 creates an indicator 500 wall thickness sufficient to allow enough light through the pump head 120 wall at the indicator 500 so that the indicator 500 can be better seen by a user.

In other embodiments of the invention, an indicator 500 may be recessed in the pump head 120 from both the bottom and the top of the pump head 120 wall. For example, and indicator 500 such as that illustrated in FIG. 6 is illustrated in FIGS. 7 through 9 in which portions of the indicator 500 are formed by recessing- or creating a smaller wall thickness-from both the top surface and the bottom surface of the pump head 120 wall.

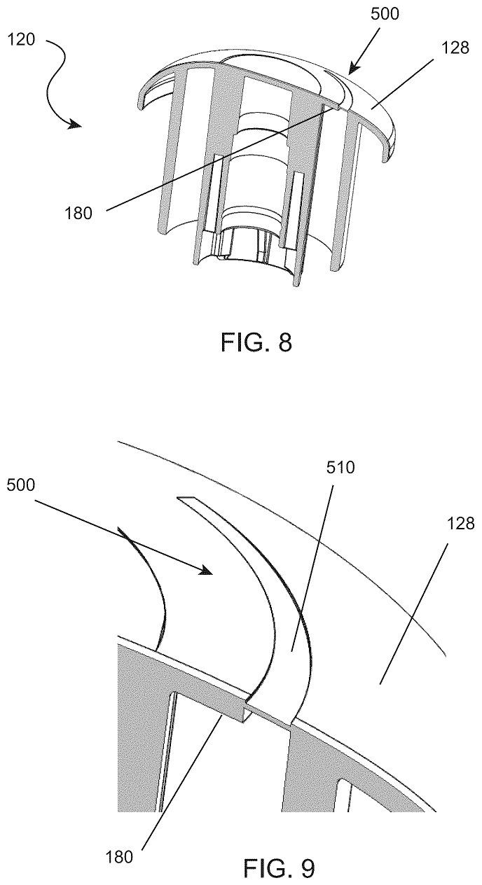

A cross-sectional view of a pump head 120 according to some embodiments of the invention is illustrated in FIGS. 8 and 9. The cross-section, for example, is taken along plane Q illustrated in FIG. 6.

As illustrated in FIG. 8, the pump head 120 includes a pump head wall 180 adjacent the indicator 500. The indicator wall 510 has a thickness that is less than that of the thickness of the pump head wall 180 adjacent the indicator 500. A close-up view of the pump head wall 180 and indicator wall 510 are illustrated in FIG. 9. As illustrated, the indicator wall 510 is formed by forming a recess in both the top and bottom of the pump head wall 180. As previously described, the indicator wall 510 may also be formed by the formation of a recess in just the bottom surface of the pump head 120, formation of a recess in just the top surface of the pump head 120, or formation of a recess in both the top and bottom surface of the pump head 120.

In such instances, the indicator 500 wall thickness may be constant—and less than the wall thickness of the adjacent pump head wall—or it may be tapered to create a visual effect through the length of the indicator 500. In some embodiments of the invention, the indicator wall 510 thickness is less than fifty percent of the adjacent pump head wall 180 thickness. In other embodiments, the thickness of the indicator wall 510 may be between twenty and eighty percent the thickness of the pump head wall 180. In other embodiments, the thickness of the indicator wall 510 may be between thirty and seventy percent the thickness of the pump head wall 180. In other embodiments, the thickness of the indicator wall 510 may be between forty and sixty percent the thickness of the pump head wall 180. In still other embodiments, the thickness of the indicator wall 510 may vary over the length of the indicator 500 in such a manner that a desired optical effect is created by the indicator 500 and light passing through the pump head 120 at the indicator wall 510.

According to various embodiments of the invention, an indicator 500 may be made in a pump head 120 or other component of a dispensing device 100 by molding a recess in a top surface of the pump head 120 to create an indicator 500 portion having an indicator wall 510 with a thickness smaller than the thickness of the pump head wall 180 adjacent the indicator 500. In other embodiments, an indicator 500 may be made in a pump head 120 or other component of a dispensing device 100 by molding a recess in a bottom surface of the pump head 120 to create an indicator 500 portion having an indicator wall 510 with a thickness smaller than the thickness of the pump head wall 180 adjacent the indicator 500. In still other embodiments, an indicator 500 may be made in a pump head 120 or other component of a dispensing device 100 by molding a recess in a top surface of the pump head 120 and in the bottom surface of the pump head 120 to create an indicator 500 portion having an indicator wall 510 with a thickness smaller than the thickness of the pump head wall 180 adjacent the indicator 500. In the various embodiments, the thickness of the indicator wall 510 may vary over the length of the indicator 500. In addition, portions of the indicator 500, or parts of the indicator wall 510, may protrude from the top surface of the pump head 120 or the bottom surface of the pump head 120 or both.

Indicators 500 and methods for making indicators 500 in dispensing devices 100 and pump heads 120 have been found to be particularly useful in those situations where a polyethylene material is being used to produce the dispensing device 100 part into which an indicator 500 is being formed. When molded, polyethylene can take on a cloudy or milky look, especially when pigments and clarifiers are not added to the material. The use of a thinned-out indicator 500 according to embodiments of the invention allows an indicator 500 that can be seen by a user to be included with a dispensing device 100 part made of polyethylene material. Further, because the indicator 500 can be seen using polyethylene material without pigments or clarifiers, the material may be more readily recycled in standard recycling streams. In some embodiments, the use of an indicator 500 according to embodiments of the invention also allows the use of less pigment because the contrast needed to see the indicator 500 is not as great given the fact that the thin nature of the indicator 500 allows light to shine through a portion thereof.

While various descriptions of embodiments of the invention are recited herein related to pump parts or pump heads and the molding of pump heads, the same indicators 500 and molding methods to form such indicators 500 may be used with trigger sprayer dispensers, closures, caps, and other dispensing products.

Having thus described certain particular embodiments of the invention, it is understood that the invention defined by the appended claims is not to be limited by particular details set forth in the above description, as many apparent variations thereof are contemplated. Rather, the invention is limited only be the appended claims, which include within their scope all equivalent devices or methods which operate according to the principles of the invention as described.

What is claimed is:

1. A dispensing device, comprising:
a container;
a pump connected to the container, comprising:
a pump head; and
an indicator molded in a portion of the pump head.

2. The dispensing device of claim 1, further comprising a product in the container.

3. The dispensing device of claim 1, wherein the indicator further comprises an indicator wall having a thickness less than a thickness of a pump head wall adjacent the indicator.

4. The dispensing device of claim 1, further comprising:
a pump head wall adjacent the indicator;
an indicator wall; and
wherein the indicator wall has a thickness less than the thickness of the pump head wall.

5. The dispensing device of claim 1, wherein the pump head comprises polyethylene.

6. A method of making an indicator in a component of a dispensing device, comprising:
providing a mold to mold the component;
providing a slide in the mold configured to create an indicator in the component molded in the mold; and
injection molding the component using the mold.

7. The method of claim 6, wherein providing a slide in the mold configured to create an indicator in the component molded in the mold further comprises providing a slide to create a recess in a bottom surface of the component during injection molding of the component.

8. The method of claim 6, wherein providing a slide in the mold configured to create an indicator in the component molded in the mold further comprises providing a slide to create a recess in a top surface of the component during injection molding of the component.

9. The method of claim 6, wherein providing a slide in the mold configured to create an indicator in the component molded in the mold further comprises providing a slide to create a recess in a bottom surface of the component and a recess in a top surface of the component during injection molding of the component.
